(19) United States
(12) Patent Application Publication
(10) Pub. No.: US 2003/0084442 A1
(43) Pub. Date: May 1, 2003

(54) TV receiver providing alternative audio tracks for a program

(76) Inventors: Jamie Kellner, Burbank, CA (US); Wayne M. Smith, La Canada, CA (US)

Correspondence Address: GOTTLIEB RACKMAN & REISMAN PC, 270 MADISON AVENUE, 8TH FLOOR, NEW YORK, NY, 100160601

(21) Appl. No.: 10/002,837

(22) Filed: Nov. 1, 2001

(51) Int. Cl. H04N 5/445

(52) U.S. Cl. 725/38

(57) ABSTRACT

A video signal processor is used to receive programs in the form of a composite video signal which incorporates a video broadcast channel, a main audio channel and an additional audio channel. The main audio channel may carry a standard audio track for the program while the additional audio channel carries an alternative audio track. The alternative audio track includes sound segments not found in the standard audio track in order that the audio be suitable for family viewing if the standard audio contains objectionable dialog, or includes specific information matching the demographics of a particular viewer population (based, for example, on geographic location). The video signal processor may be provided as a stand-alone device or may be incorporated into a TV receiver, a VCR, a DVD player, etc.

### BACKGROUND OF THE INVENTION

A. Field of the Invention

This invention pertains to a video signal processor such as a TV receiver that processes a secondary audio program (SAP) channel with an alternative audio track in accordance with viewer preferences regarding the program content or viewer demographic information such as geographic location.

B. Description of the Prior Art

Early TV receivers received only a few program channels having a single mono audio track. As TV receivers evolved into the primary source of home entertainment for a majority of the population, program providers and TV manufacturers cooperated to expand the capabilities of TV systems by providing additional services so that a wide range of video programs could be enjoyed by a more diverse population, including people with various disabilities or people speaking different languages. These services include closed captions (CC) to assist people with hearing disabilities; descriptive video services (DVS), which provide a narrative description of action or other scene related information (for example, facial expressions), to aid those with visual impairments; and multi-language audio tracks to allow a viewer to select a language he prefers when viewing a program.

One problem with present-day TV receivers concerns programs with objectionable language that may be unsuitable for children. Program producers have responded to concerns regarding questionable content by providing ratings to alert parents to objectionable audio or visual content. However, when a program with an objectionable rating is broadcast, parents have only three alternatives: (1) turn off the TV receiver, (2) tune the TV receiver to a different channel, or (3) send children away. And in the absence of adult supervision, warnings in the form of ratings do not effectively keep children from watching a given program.

An effort to cure this deficiency is the “V-chip.” V-chips can be installed in TV receivers and preset by parents so that when a program rated as inappropriate for children (as indicated by a code embedded in the composite video signal) is broadcast, both the audio and visual parts of the program are blocked. However, the V-chip is inflexible in that it applies across the board to all channels in the same way. In addition, the V-Chip blocks reception of the entire program whereas only certain portions of the program, or program dialogue, may be objectionable.

### OBJECTIVES AND ADVANTAGES OF THE INVENTION

In view of the aforementioned disadvantages of the prior art, it is an objective of the present invention to provide a video signal processor such as a TV receiver that receives television programs containing alternative audio signals that have been edited for content and are thus more suitable for family viewing.

Another objective of the invention is to provide a TV receiver that is capable of receiving alternative audio signals that are tailored to a demographic characteristic of the viewer such as his geographic location.

A further objective is to provide a TV receiver that receives alternative audio signals that are easily incorporated into a standard composite video signal.

Yet another objective is to provide a broadcasting system adapted to transmit different composite signals to different viewers based on the viewers' demographic characteristics.

Briefly, a video signal processor such as a TV receiver constructed in accordance with our invention processes a composite video signal received from a broadcaster that includes a video channel and a main audio channel which represent standard video and audio programs, and a secondary audio channel that carries an alternative audio track. In one embodiment of the invention, the alternative audio track is derived from the standard audio track, for example, by deleting dialog that may not be suitable for children and replacing the same with milder or more acceptable dialog. In another embodiment, the standard audio track may be directed to a generic audience while the alternative audio track may be tailored for a specific audience, based, for example, on geographic location.

Our invention further includes a broadcasting system in which several composite video signals are transmitted to TV receivers disposed at different geographic locations. All the composite video signals have the same video and main audio channels but different alternative audio tracks,

Since the TV receiver includes a video signal processor formed of a tuner and output circuitry generating output video and audio signals, a TV screen and speakers, each of these elements can be provided separately. In this latter configuration, the video signal processor can be provided as a stand-alone device, or can be incorporated into other devices such as VCRs, personal video recorders, DVD players, etc.

### BRIEF DESCRIPTION OF THE DRAWINGS

FIG. 1 shows a block diagram of a conventional TV receiver receiving a composite video signal;

FIG. 1A shows diagrammatically the conventional video and audio channels imbedded in a composite video signal;

FIG. 2 shows a block diagram of a TV receiver constructed in accordance with this invention;

FIG. 2A shows diagrammatically the signals imbedded in a composite video signal in accordance with this invention;

FIG. 3 shows diagrammatically a comparison between the contents of a standard audio track and an alternative audio track; and

FIG. 4 shows a diagrammatic view of a broadcasting system with composite video signals being transmitted to TV receivers at different geographic locations.

### DETAILED DESCRIPTION OF THE INVENTION

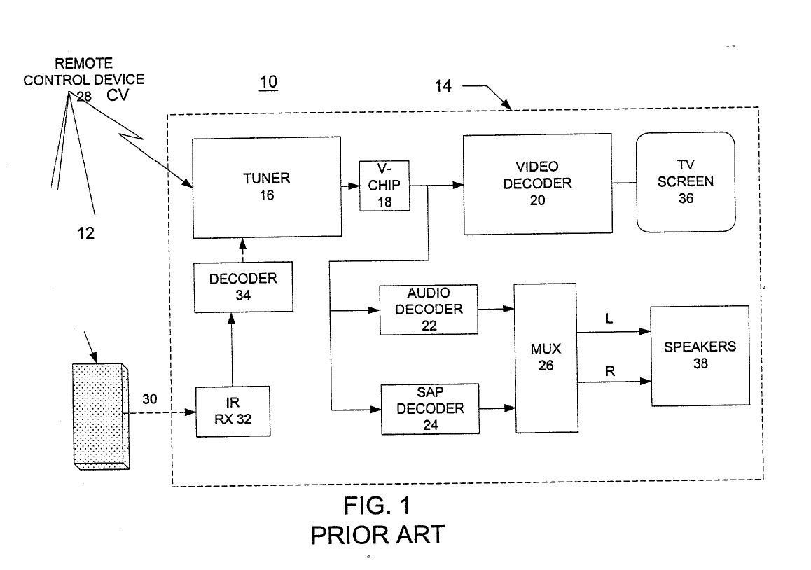

FIG. 1 shows a broadcasting system 10 in which a tower 12 sends a composite video signal CV to a conventional TV receiver 14. TV receiver 14 includes a tuner 16, a V-chip 18, a video decoder 20, an audio decoder 22, an SAP decoder 24 and a multiplexer 26. The audio decoder 22 SAP 24 and multiplexer 26 can be provided in a single integrated chip however, discrete elements are shown for the sake of clarity.

The TV receiver 14 is controlled by a remote control device 28 which sends a viewer's commands to the TV receiver 14 through an infrared link 30 and an IR receiver 32. Other communication means including ultrasonic or RF signals may be used as well. The remote control device 28 is used by the viewer to perform various functions such as channel selection, volume selection, muting, SAP preference and so on. The output of IR receiver 32 controls decoder 34, for example, to tune tuner 16 to a particular channel. In addition, the decoder 34 also generates control signals that control the multiplexer 26 to select either the main or the alternate audio track for the speakers 38, as discussed in more detail below.

As shown in FIG. 1A, the composite video signal CV received by receiver 14 may include a video, a main audio, a closed captioned (CC) and a secondary audio program (SAP) channel. The SAP channel carries either foreign language audio tracks (L) or descriptor video services (DVS) audio tracks. In each case, the audio tracks carried by the SAP channel are very different from the standard audio tracks on the main audio channel.

When the TV receiver 14 is turned on, the tuner 16 receives the composite video signal CV and its component channels, and sends them to the V-chip 18. The V-Chip (when activated) checks the rating of the program being received, and if it is acceptable then it sends the same to the video audio signal processing chip 20, the audio decoder 22 and the SAP decoder 24. The video signal decoder generates video signals for a TV screen 36.

The audio decoder 22 generates the audio track corresponding to the signals on the main audio channel. The SAP decoder generates the audio track from the SAP channel. These audio tracks are fed to the multiplexer 26 which selects one of these tracks for speakers 38 in accordance with the control signals received from decoder 34.

The TV receiver 14 is programmed by pressing a sequence of predetermined keys (not shown) on the remote control device 26. As part of this programming, an electronic latch (not shown) is set so that it is either on or off to indicate whether the SAP channels should be selected or not. When the SAP channel is selected, it is maintained as the ‘active’ audio channel by the multiplexer 26 (with the exception noted below) until it is de-selected by the latch through another setup or programming sequence.

If the SAP channel has not been selected, the multiplexer 26 automatically selects the standard audio track from decoder 22.

Typically, when the SAP channel has been selected, the SAP decoder 24 decodes and monitors the SAP channel. As long as appropriate SAP signals (typically FM signals) are received on this channel, they are decoded, and corresponding audio signals are provided to speakers 24. As discussed above, the processed audio signal may be DVS or dialog in another language. If no SAP signal is received, the audio signal is muted. The multiplexer 26 may also be structured so that if the SAP channel has been selected and is present, then one of the output lines from the audio decoder p 22, for example, the output line for signal L, is used to output the SAP signal, while the other output line R is used to generate a monophonic version of the standard audio track. The following table depicts the typical operation of the audio decoder 22, the SAP decoder 24 and the multiplexer 26:

| | | SIGNAL | STEREO | SAP |
|---|---|---|---|---|
| LEFT | RIGHT | RECEIVED | SELECTED | SELECTED |
| MUTE | MUTE | POOR OR | YES | NO |
| | | NOISY SAP | | |
| LEFT | RIGHT | STEREO | YES | NO |
| MONO | MONO | POOR OR | NO | YES |
| | | NOISY | | |
| | | STEREO | | |
| MONO | MUTE | POOR OR | NO | YES |
| | | NOISY SAP | | |
| MONO | SAP | SAP | NO | YES |
| MONO | MUTE | POOR OR | NO | YES |
| | | NOISY SAP | | |

The content of the SAP channel is determined by the program provider of the particular program. As mentioned previously, the SAP channel may carry DVS or dialog in an alternate language.

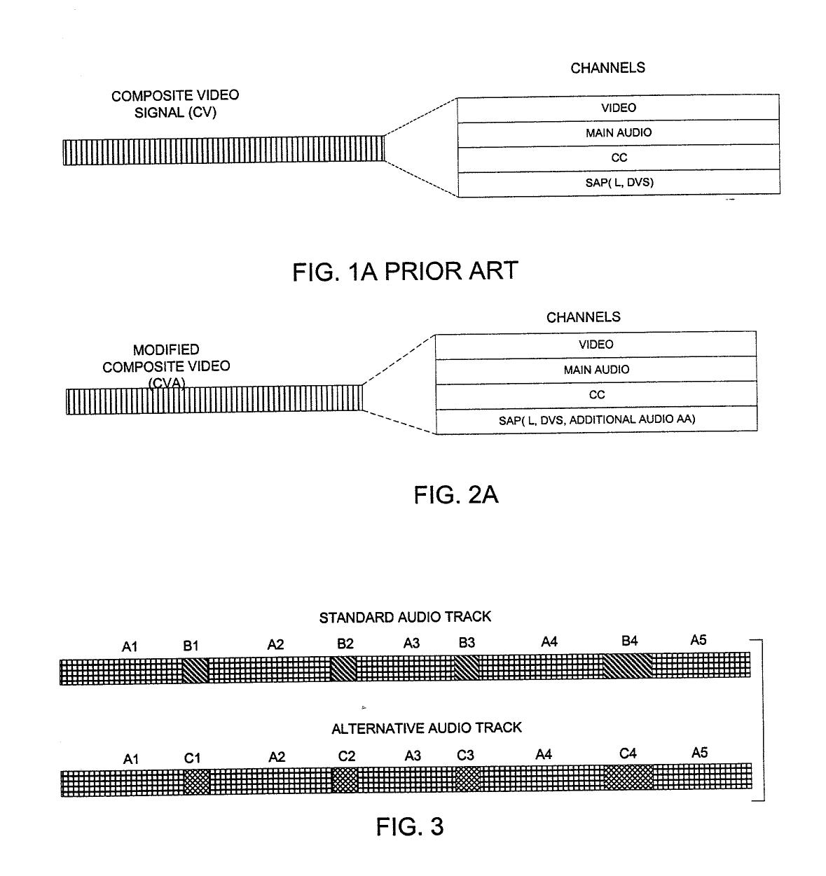

In the present invention, the TV receiver 14A receives a composite video signal CVA which, as shown in FIG. 2A, is the conventional CV signal modified by incorporating in the SAP an additional audio channel (AA). This additional audio channel carries an alternative audio track which may be derived from the standard audio track on the main audio channel. In some cases, the alternative audio track may be nearly identical to the standard audio track and synchronized to the video signal to preserve proper correspondence between its dialog and the video. The differences between the standard and alternative audio signals is that certain words or phrases in the standard audio signal are replaced by the producer, a subsequent distributor or a broadcaster with other words or phrases, or with nothing at all. For example, in one embodiment of the invention, words or phrases that may be objectionable for children may be either replaced with other words or phrases that are acceptable, or simply omitted. Therefore, the main audio channel in this instance carries a standard audio track that is more suited for mature audiences, while the additional audio channel contains dialog in the same language and with substantially the same content that is more suitable for children.

Regional preferences may dictate other kinds of changes to the standard audio track. For example, a commercial may be incorporated in a program with the main audio channel being generic to viewers in the United States, while the additional audio channel may be used for audio which is specific to Canada. Thus, viewers in the United States and Canada can watch the same program, but the viewers in Canada can listen to different audio than viewers in the United States.

Alternatively, the main audio channel may be used for audio with generic information applicable for all the viewers in the United States (for example, an 800 number for a product being advertised). The additional audio channel may then be used for alternative audio generic to specific locations. For example, the alternative audio may include the name or telephone number of a store in Los Angeles, New York, Atlanta, New Orleans, etc. Viewers in each of these locations receive a different additional audio channel.

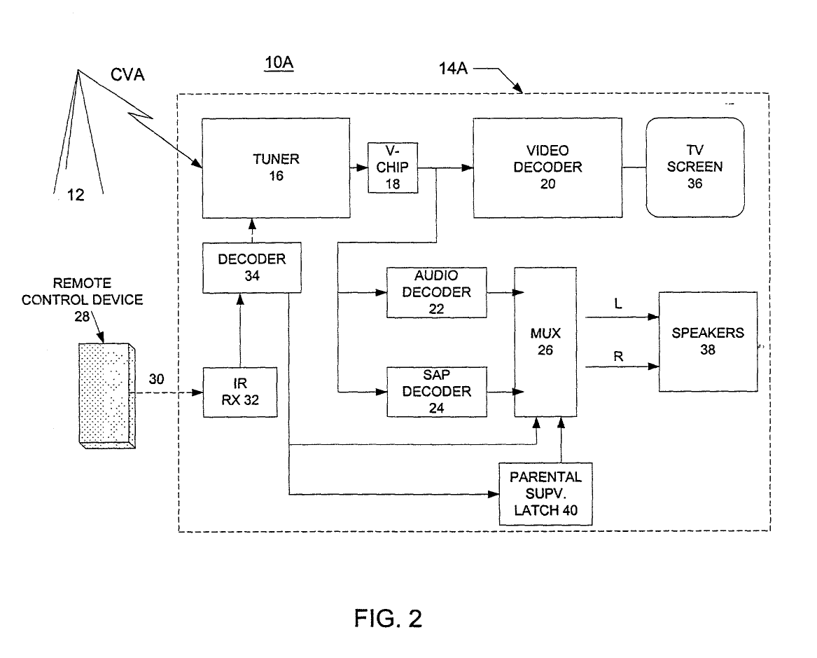

FIG. 3 illustrates the content of the standard audio track on the main audio channel and the alternative audio tracks carried by the additional audio channel. For example, the top portion of this Figure may represent the standard audio track associated with a program for mature audiences and therefore may include several segments that are not suitable for children. It is expected that the number and duration of these segments may be generally small and may be somewhat randomly distributed between segments that are acceptable for all audiences. Therefore in FIG. 3 segments with acceptable language are designated as A segments, with B segments containing objectionable language. In other words, the standard audio track consists of a sequence of alternating A and B segments as shown, which can be represented as A1, B1, A2, B2, A3, B3, A4, B4, A5 . . . In FIG. 3 the sizes of the B segments are exaggerated for the sake of clarity, it being understood that they are generally much shorter than the A segments. More particularly, A segments may be several minutes or even hours long while the B segments may each be a couple of seconds long. Alternatively, the B segments may represent the portions of the standard audio track that may be selectively changed for various specific regions or audiences of specific demographic concentrations.

The producer, broadcaster or other intermediate party can generate the alternative audio track which is a modified version of the standard audio track. As shown in FIG. 3, the alternative audio track is obtained by replacing the B segments in the standard audio track with new C segments. These C segments may contain alternative acceptable language to the objectionable language of the B segments. Thus, the alternative audio track may be represented as a sequence of A and C segments arranged in the order: A1, C1, A2, C2, A3, C3 etc. The A segments on the additional audio track are identical to the A segments on the main audio track. The C segments correspond in a one-to-one relationship to the B segments and each segment Cn has, exactly the same length as the segment Bn that it replaces. Therefore, all the segments on both channels remain synchronized with the video signal.

The SAP is either enabled or disabled for all the program channels. Alter-natively, the SAP channel is enabled or disabled on a channel-by-channel basis as disclosed in commonly assigned copending application Ser. No. ______ filed ______ and entitled A TV RECEIVER WITH INDIVIDUALLY PROGRAMABLE SAP CHANNEL, incorporated herein by reference.

Preferably, the TV receiver 14A is provided with a parental supervisory latch 40. Latch 40 can be set by entering an appropriate code into remote control device 28 and transmitting the same to the decoder 34. The decoder 34 uses this code to generate a control signal for setting the latch 40.

After it has been set, latch 40 operates forces the multiplexer to select only the secondary audio track from the SAP and any control signals from the remote control device 28 during this period are ignored. In this manner, a parent can in effect lock the set 14A so that children can only hear the secondary audio track.

The parental supervisory latch 40 can be reset by entering a release code into the remote control device 28. Once the latch 40 is reset, the multiplexer 26 operates in a normal manner.

It has been assumed that the main audio channel is designated to carry the audio tracks for mature audiences and the alternative audio tracks on the additional audio channel are suitable for all family audiences, including children. Of course, the channels can be reversed so that the audio tracks that are family oriented are carried by the main channel and the audio tracks for mature audiences are carried by the additional audio channel. In this case, the latch 40 locks the multiplexer to allow only the main sound track to be heard.

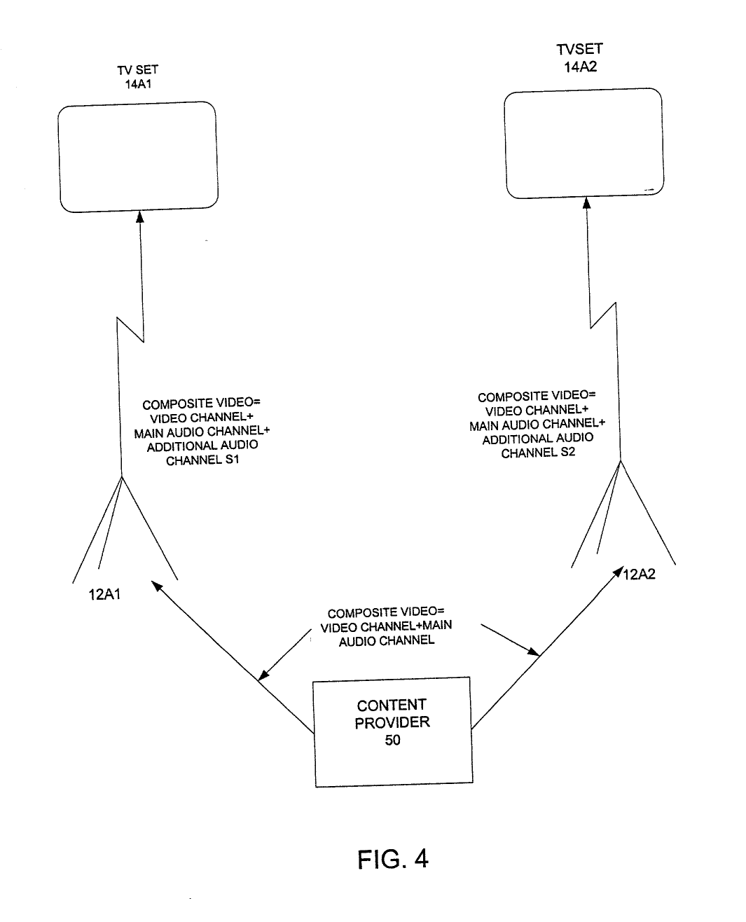

As discussed above, the additional audio channel may be used to transmit alternative audio tracks that are customized for viewers in different geographic areas. Such a system is shown in FIG. 4. In this system, a content provider 50 provides a composite video signal consisting of a video and a main audio channel to two different broadcasters 12A1 and 12A2. In this case, the main audio channel is generic to all viewers and geographic areas. The two broadcasters provide broadcasts to TV receivers 14A1 and 14A2, disposed at different geographical locations. For example, TV receiver 14A1 may be in New York and TV receiver 14A2 may be in Los Angeles. Each broadcaster adds its own additional audio channel. For example, broadcaster 12A1 may add a track on the additional audio channel AA1 which includes alternative audio tracks that contain New York-specific information while broadcaster 12A2 may add an additional channel AA2 with alternative audio tracks that contain information specific to Los Angeles. The two TV receivers 14A1 and 14A2 can be set by the respective viewers to listen to either the main audio channel or the additional audio channel, as desired.

In FIG. 2, the elements controlling the audio track being played, i.e., audio decoder 22, SAP decoder 24, multiplexer 26 and latch 40 are shown as discrete components for the sake of clarity. However, they may be combined into a single sound processing chip.

The TV receiver 14A described above includes in effect a video signal processor having a tuner and output circuitry generating output video and audio signals, a TV screen 36 and speakers 38. However, each of these elements may be provided separately. In this latter configuration, the video signal processor may be provided as a self-contained stand-alone unit, or may be incorporated into another device, such as a VCR, a DVD player, a personal video recorder.

Obviously, various modifications may be made to the invention without departing from the scope of the invention as defined in the appended claims.

We claim:

1. A video signal processor comprising:
a tuner adapted to receive a composite video signal, said composite video signal including a video channel that carries a video signal for an audio-visual program, a main audio channel that carries a standard audio track for said program, and a SAP channel carrying an alternative audio track for said program, said alternative audio track being a modified version of said standard audio track;
a selector adapted to select one of said standard and said alternative audio tracks as the active audio track; and
output circuitry coupled to said tuner and generating output audio and video signals, said output audio signals corresponding to said active audio track.

2. The video signal processor of claim 1 wherein said standard audio track is composed of first segments and said alternate audio track is composed of second segments, and a substantial number of said first and second segments are identical.

3. The video signal processor of claim 1 wherein said standard audio track includes a sequence of A segments and B segments and said alternative audio track includes a sequence of A segments and C segments, and said B segments are different from said C segments.

4. The video signal processor of claim 3 wherein said every B segment in said standard audio track is replaced by a corresponding C segment in said alternative audio track.

5. The video signal processor of claim 1 wherein one of said main and alternative audio tracks contains objectionable material for children and in the other of said main and alternative audio tracks said objectionable material is absent.

6. The video signal processor of claim 1 wherein said main and alternative audio tracks are customized for viewers with different demographic characteristics.

7. The video signal processor of claim 1 further comprising a latch having a set and a reset mode responsive to a code, wherein said selector is coupled to said latch and is adapted to designate an active audio track when said latch is set which cannot be changed by a viewer without resetting the latch.

8. A video signal processor comprising:
a tuner adapted to receive a composite video signal, said composite video signal including a video broadcast channel that carries a video track for an audio-visual program, a main audio channel that carries a standard audio track for said program and an SAP channel with an alternative audio track for said program, each of said audio tracks being composed of sequential sound segments, wherein said alternative audio track includes segments derived from said standard audio track;
a selector adapted to select one of said standard and alternative audio tracks as the active audio track; and
output circuitry coupled to said tuner and generating output audio and video signals, said audio signal corresponding to said active audio track.

9. The video signal processor of claim 8 wherein said standard audio track comprises sequential A segments and B segments, and said alternative audio track comprises sequential A segments and C segments, said C segments being different from said B segments.

10. The video signal processor of claim 9 wherein said B segments contain objectionable language and said C segments contain unobjectionable language.

11. The video signal processor of claim 9 wherein said C segments are targeted for viewers having specific demographics.

12. The video signal processor of claim 11 wherein said B segments are targeted to a general viewer population and said C segments are targeted to a viewer population at a specific geographic location.

13. The video signal processor of claim 8 wherein said selector is responsive to commands by a user.

14. The video signal processor of claim 13 further comprising a latch having a set and a reset mode responsive to a code, wherein said latch is coupled to said selector to lock said selector independently of said commands.

15. A broadcasting system comprising:
a broadcasting apparatus adapted to transmit a composite video signal, said composite video signal including a video broadcast channel that carries a video signal for an audio-visual program, a main audio channel that carries a standard audio track for said program, and an SAP channel that carries an alternative audio track for said program, said alternative audio track being a modified version of said standard audio track; and
a plurality of video signal processors adapted to receive said composite video signal and to generate corresponding output audio and video signals, said video signal processors including a selector adapted to select one of said main and alternative audio tracks as the active audio track, said video signal processors generating said output audio signal corresponding to said active audio track.

16. The system of claim 15 wherein said standard audio track is composed of first segments and said alternative audio track is composed of second segments, and a substantial number of said first and second segments are identical.

17. The system of claim 15 wherein said standard audio track includes a sequence of A segments and B segments and said alternative audio track includes a sequence of A segments and C segments, and said C segments are different from said B segments.

18. The system of claim 17 wherein every B segment in said standard audio track is replaced by a corresponding C segment in said alternative audio track.

19. The system of claim 15 wherein one of said main and alternative audio tracks contains objectionable material for children, and in the other of said main and alternative audio tracks said objectionable material is absent.

20. The system of claim 15 wherein said main and alternative audio tracks are customized for viewers with different demographic characteristics.

21. The system of claim 15 wherein said main audio track is broadcast to viewers independent of their locations, and said alternative audio track is customized for viewers with specific demographic characteristics.

22. A broadcasting system comprising:
a broadcasting apparatus adapted to transmit a composite video signal, said composite video signal including a video channel that carries a video signal for an audio-visual program, a main audio channel that carries a standard audio track for said program, and an additional audio channel that carries an alternative audio track for said program, each of said audio tracks being composed of sequential sound segments, wherein said alternative audio track is modified by replacing only some of the segments of said standard audio track with other segments not found in said standard audio track; and
a plurality of TV receivers adapted to receive said composite video signal and to display images corresponding to said video channel, said TV receivers generating sounds corresponding to one of said standard and alternative audio tracks.

23. The system of claim 22 wherein each TV receiver includes a selector that determines which of said audio tracks is the active audio track.

24. The system of claim 23 wherein said selector is responsive to commands from a user.

25. The system of claim 24 further comprising a latch responsive to a code to override said commands and lock said selector into a predetermined position.

26. The system of claim 22 wherein said additional audio channel is an SAP channel.

27. The system of claim 22 wherein said standard audio track comprises A segments and B segments, and said alternative audio track comprises A segments and C segments, said C segments being different from said B segments.

28. The system of claim 27 wherein said B segments contain objectionable language and said C segments contain unobjectionable language.

29. The system of claim 27 wherein said B and C sound segments are targeted for viewers having different demographics.

30. The system of claim 29 wherein said B segments are targeted to viewers independently of their geographic location and said C sound segments are targeted to viewers at a specific geographic location.

31. A system comprising:
a first signal processor disposed at a first geographic location;
a second signal processor disposed at a second geographic location;
a broadcasting apparatus adapted to transmit composite video signals, said composite video signals including a video broadcast channel that carries a video signal for an audio-visual program, a main audio channel that carries a standard audio track for said program, said standard audio track being generic to both TV receivers, and an additional audio channel that carries one of a first and a second alternative audio track for said program, each of said audio tracks being composed of sequential sound segments, wherein said alternative audio track is derived by replacing only some of the segments of said standard audio track with other segments not found in said standard audio track; a composite video signal with the first alternative audio track is transmitted to said first video signal processor and a composite video signal with the second alternative audio track is transmitted to said second video signal processor; and said video signal processors are adapted to receive said composite video signals and to generate corresponding output audio and video signals, with said output audio signals corresponding to one of said audio tracks.

32. The system of claim 31 wherein said additional audio channel is in a SAP channel.

33. A TV receiver comprising:
a tuner adapted to receive a composite video signal, said composite video signal including a video channel that carries a video signal for an audio-visual program, a main audio channel that carries a standard audio track for said program, and a SAP channel carrying an alternative audio track for said program, said alternative audio track being a modified version of said standard audio track;
a screen adapted to display images corresponding to said video signal;
a selector adapted to select one of said standard and said alternative audio tracks as the active audio track; and
a speaker adapted to generate sounds corresponding to said active audio track.

34. The TV receiver of claim 33 wherein said standard audio track is composed of first segments and said alternate audio track is composed of second segments, and a substantial number of said first and second segments are identical.

35. The TV receiver of claim 33 wherein said standard audio track includes a sequence of A segments and B segments and said alternative audio track includes a sequence of A segments and C segments, and said B segments are different from said C segments.

36. The TV receiver of claim 35 wherein said every B segment in said standard audio track is replaced by a corresponding C segment in said alternative audio track.

37. The TV receiver of claim 33 wherein one of said main and alternative audio tracks contains objectionable material for children and in the other of said main and alternative audio tracks said objectionable material is absent.

38. The TV receiver of claim 33 wherein said main and alternative audio tracks are customized for viewers with different demographic characteristics.

39. The TV receiver of claim 33 further comprising a latch having a set and a reset mode responsive to a code, wherein said selector is coupled to said latch and is adapted to designate an active audio track when said latch is set which cannot be changed by a viewer without resetting the latch.

40. A composite video signal, said composite video signal including a video channel that carries a video signal for an audio-visual program, a main audio channel that carries a standard audio track for said program, and a SAP channel carrying an alternative audio track for said program, said alternative audio track being a modified version of said standard audio track.

41. The composite video signal of claim 40 wherein said standard audio track is composed of first segments and said alternate audio track is composed of second segments, and a substantial number of said first and second segments are identical.

42. The composite video signal of claim 40 wherein said standard audio track includes a sequence of A segments and B segments and said alternative audio track includes a sequence of A segments and C segments, and said B segments are different from said C segments.

43. The composite video signal of claim 42 wherein said every B segment in said standard audio track is replaced by a corresponding C segment in said alternative audio track.

44. The composite video signal of claim 40 wherein one of said main and alternative audio tracks contains objectionable material for children and in the other of said main and alternative audio tracks said objectionable material is absent.

45. The composite video signal of claim 40 wherein said main and alternative audio tracks are customized for viewers with different demographic characteristics.
